(19) United States
(12) Patent Application Publication
(10) Pub. No.: US 2026/0081202 A1
(43) Pub. Date: Mar. 19, 2026

(54) SINGLE STATION BATTERY MANUFACTURE

(71) Applicant: FORD GLOBAL TECHNOLOGIES, LLC, Dearborn, MI (US)

(72) Inventors: Michael ORR, Ferndale, MI (US); Paul John BOJANOWSKI, Macomb Township, MI (US)

(21) Appl. No.: 18/887,873

(22) Filed: Sep. 17, 2024

(51) Int. Cl. H01M 10/04; G01N 21/89; H01M 50/536

(52) U.S. Cl. CPC H01M 10/0409; G01N 21/8914; H01M 10/0431; H01M 10/0468; H01M 50/536

(57) ABSTRACT

A system for manufacturing battery cells that utilizes a single battery assembly station for trimming and welding operations is presented. The system includes a laser mask with defined windows and a laser configured to direct beams through the windows. A platform is operable to perform planar translation of the battery cell within the laser mask, allowing the beams to sequentially trim current collector foils and weld tabs to the current collector foils.

### TECHNICAL FIELD

This disclosure relates to battery manufacturing.

### BACKGROUND

In current battery manufacturing processes, pouch cell foil tabs are joined to lead tabs using ultrasonic welding, which often involves multiple stations to complete the operation for each side of the cell. While ultrasonic welding may be effective, it requires multiple stations to ensure adequate joint strength.

### SUMMARY

A system for manufacturing battery cells includes a single battery assembly station with a laser mask defining windows, a laser configured to generate beams through the windows, and a platform operable to move a battery cell within the laser mask for the beams to sequentially trim current collector foils of the battery cell and weld tabs to the current collector foils. The windows may include a first set of windows for trimming operations and a second set of windows for welding operations. In some configurations, the system further includes a vision system integrated within the single battery assembly station for performing dimensional checks of the current collector foils and tabs. The platform may be configured to move in at least two dimensions to position the battery cell relative to the laser mask. In other configurations, a control system may be programmed to coordinate the movement of the platform and firing of the laser to perform trimming and welding operations in a predetermined sequence. The laser may be a fiber laser configured to operate at different power levels for trimming and welding operations. The laser mask may include a scrap suction system.

A method for manufacturing battery cells includes trimming current collector foils of a battery electrode jellyroll using a laser, performing a dimensional check of the trimmed current collector foils using a vision system, welding tabs to the trimmed current collector foils using the laser, and performing a dimensional check of the welded tabs. The method may include adjusting parameters of the laser between trimming and welding operations. Trimming and welding operations may be performed at a single workstation without moving the battery electrode jellyroll to a separate station. The method may include applying a clamping force to the current collector foils during welding operations. Dimensional checks may be performed using machine vision algorithms to analyze images of the trimmed foils and welded tabs. Dimensional check data may be stored. The laser beam may be guided through different windows in a laser mask for trimming and welding operations.

A battery cell assembly system includes a single battery cell workstation with an integrated vision system, a laser source, a beam delivery system defining a path for directing a laser beam from the laser source, a platform operable to translate a battery, within the single battery cell workstation, for the laser beam to sequentially trim and weld foil tabs of the battery at the workstation, and a conveyor configured to transport battery cells to and from the platform within the single battery cell workstation. A fume suction system may be configured to remove fumes generated during the laser trimming and welding operations. The beam delivery system may include a scrap suction system configured to collect and remove foil scraps produced during laser trimming operation. The platform may be configured to move in at least two dimensions to position the battery cell relative to the beam delivery system. The laser source may be configured to produce different beam profiles for trimming and welding operations. A control system may be programmed to coordinate translation of the platform and firing of the laser source to perform trimming and welding operations in a predetermined sequence.

### BRIEF DESCRIPTION OF THE DRAWINGS

FIG. 1 is a schematic diagram of a battery manufacturing system;

FIG. 2 is a schematic diagram of components of the battery manufacturing system of FIG. 1; and

FIGS. 3A-3D are diagrams of a battery manufacturing process utilizing the battery manufacturing system of FIG. 1 and components of FIG. 2.

### DETAILED DESCRIPTION

In accordance with this disclosure, specific embodiments of the battery cell manufacturing systems and methods are presented. These embodiments illustrate an innovative approach to enhancing battery production through the integration of laser-assisted processes for trimming and welding operations. The disclosed systems employ laser masks, platforms for planar translation, and vision systems to achieve precise trimming of current collector foils and welding of tabs in a single workstation.

The accompanying figures and descriptions are provided for illustration and do not encompass all potential configurations. Certain features may be accentuated or simplified to emphasize key aspects of the manufacturing system. Accordingly, the disclosed structural and functional details serve to provide foundational guidance for skilled practitioners in implementing various embodiments of the claimed subject matter, without limiting the scope of the invention.

In lithium-ion battery electrode jellyroll construction, several components work together to form an energy storage system. The jellyroll structure often includes three primary layers: the anode, the cathode, and the separator.

The anode often includes a metal current collector foil coated with an active material such as graphite or lithium titanium oxide. Copper may be chosen due to its electrical conductivity, which allows electrons to flow freely between the active material and the external circuit. The anode's active material serves as the site for lithium-ion intercalation during charging, and the current collector helps distribute the current evenly across the electrode.

On the cathode side, metal foil may be used as the current collector, typically coated with active materials like lithium nickel manganese cobalt oxide or lithium iron phosphate. Aluminum may be chosen for its light weight and good conductivity. During discharge, lithium ions move from the anode to the cathode through the separator, and the current collector functions to deliver the electrons generated at the cathode back to the circuit.

Separating the anode and cathode is a thin, porous membrane. While the separator does not directly participate in electron conduction, it allows lithium ions to pass through while preventing the anode and cathode from making direct contact, which would cause a short circuit.

Current collector tabs are typically extensions of the current collector foils and are welded or connected to the external terminals of the battery. One tab is connected to the anode's current collector and another to the cathode's current collector.

A battery cell manufacturing system described herein aims to increase production efficiency and quality control by consolidating multiple manufacturing steps—pre-welding, trimming, vision checking, and main welding—into a single workstation. This consolidation may reduce the overall factory footprint and potentially reduce the time and energy required for these operations.

The system may include an automatic conveyor and feed mechanism for the foils and tabs. This automated material handling system may include precision forms and guides to ensure accurate alignment of the foils as they enter the workstation. The feed system for the tabs may utilize a pick-and-place mechanism with vacuum grippers or mechanical clamps to precisely position the tabs onto the foils. The conveyor system may be synchronized with the laser operations to maintain continuous flow and optimal processing speed.

The system utilizes laser technology capable of performing both trimming and welding. The laser source may be a fiber laser, selected for its potential to switch between different power levels and beam characteristics. For trimming operations, the laser may operate at a lower power with a focused beam, typically in the range of 100-500 watts. When transitioning to welding operations, the laser's power may be increased to 1-3 kilowatts, and the beam profile may be adjusted to create a wider pattern, potentially using beam-shaping optics.

The system may incorporate a laser mask with defined windows for different operations. This mask may be made of copper or aluminum with a highly reflective coating to withstand high laser powers. The mask could potentially be water-cooled to manage thermal loads during continuous operation. The mask design may include precision-machined apertures for beam shaping, with tolerances in the range of ±10 microns.

A workpiece handling system may be included, featuring a platform capable of movement in at least two dimensions. This platform may utilize linear motors or ball screw actuators for precise positioning, with potential accuracies of ±5 microns. The platform's movement may be synchronized with the laser operations through a real-time control system with a loop time of less than 1 millisecond.

The workstation may integrate a machine vision system to perform dimensional checks of the trimmed foils and welded tabs. This system may employ high-resolution cameras with resolutions up to 20 megapixels, coupled with telecentric lenses to minimize optical distortions. Image processing algorithms may analyze the captured images in real-time, potentially using edge detection and pattern-matching techniques with sub-pixel accuracy.

The system may incorporate a fume extraction system and a foil scrap collection mechanism. The fume extraction system may use high-efficiency particulate air filters capable of removing particles as small as 0.3 microns with 99.97% efficiency. The foil scrap collection system may employ a vacuum-based approach with cyclone separators to remove and collect trimmed material.

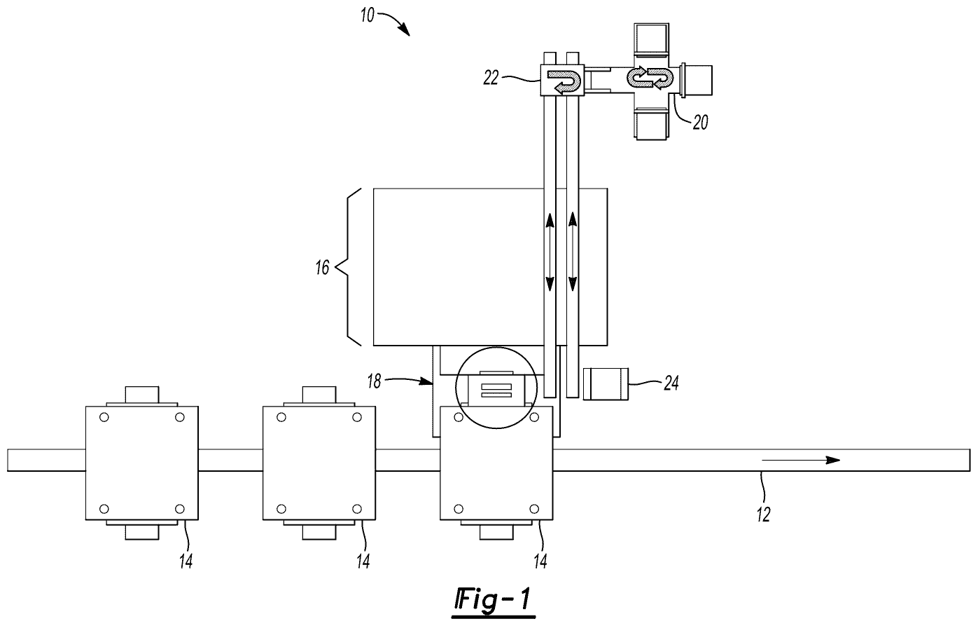

FIG. 1 is a schematic diagram of a battery cell manufacturing system 10, which consolidates multiple manufacturing steps into a single workstation for efficient battery cell production. The system 10 includes a conveyance mechanism 12 that transports battery cell components through the manufacturing process. Platforms 14 are positioned along the conveyance mechanism 12, supporting and stabilizing the battery cell components during various stages of assembly. A trim and weld fixture 16, serves as the primary workstation for the consolidated tab welding operation. This fixture 16 acts a mask or beam directing device that guides the laser for both trimming and welding operations, enabling the execution of multiple functions within a single station. A laser scanner 18 works in conjunction with the trim and weld fixture 16, generating and directing the laser beam used for both foil trimming and tab welding, adjusting its power and characteristics as needed for each operation. The system 10 includes a tab carousel 20 that stores and dispenses lead tabs, working in tandem with a lead tab pick and place mechanism 22, which transfers tabs from the tab carousel 20 to the trim and weld fixture 16 for precise placement and welding. Adjacent to the trim and weld fixture 16 is a tab alignment table 24, ensuring accurate positioning of the lead tabs before they are introduced to the welding area within the fixture 16. The system 10 executes a one station battery manufacturing process, including six sequential sub-steps: foil gather, laser foil trim, foil vision analysis, tab introduction, tab laser weld, and tab vision analysis. These steps are performed within the trim and weld fixture 16, utilizing the laser scanner 18 for trimming and welding operations, with integrated vision systems providing real-time quality control.

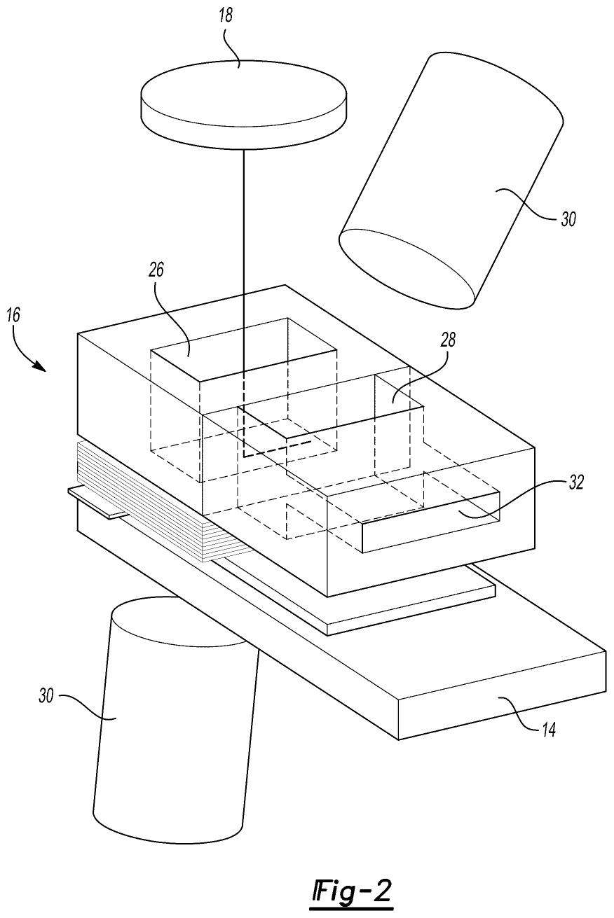

FIG. 2 is a schematic view of the trim and weld fixture 16 of the battery cell manufacturing system 10. The trim and weld fixture 16 has the platform 14 positioned underneath, the platform 14 may include a datum plate that utilizes servocontrols for X and Y coordinate translation of battery components on the platform 14. This movement of the platform 14 allows for precise positioning of battery components during the manufacturing steps of trimming and welding. The fixture's design incorporates a laser weld window 26 and a laser trim window 28, both positioned to allow the laser scanner 18 mounted above to perform welding and trimming operations, respectively. This configuration enables transition between processes without mechanical tool changes or workpiece movement. The trim and weld fixture 16 includes fume suction mechanisms 30 positioned at the top and bottom of the workspace, along with a foil scrap suction system 32 for removal of trimmed material. The laser scanner 18 may direct its beam through the appropriate window as needed for either trimming or welding.

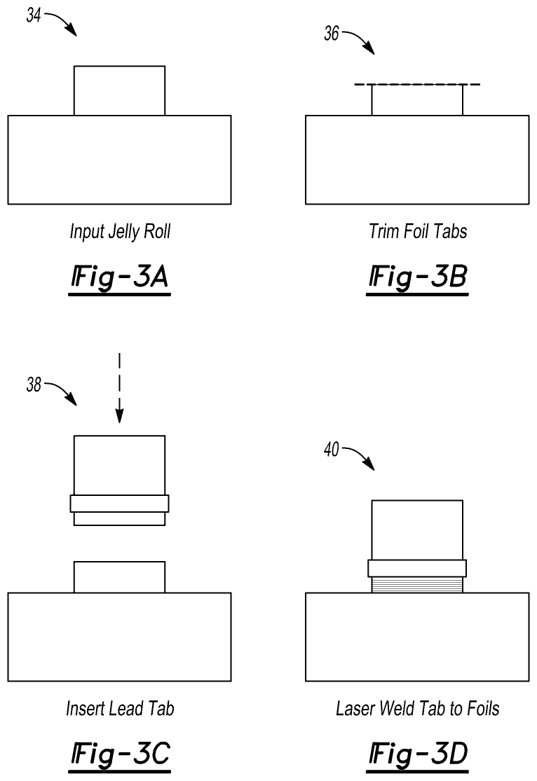

FIGS. 3A-D show the operational sequence of the trim and weld fixture 16 within the battery cell manufacturing system 10. FIG. 3A shows an initial stage 34 where the input battery components are positioned on the platform 14 within the trim and weld fixture 16, ready for processing. FIG. 3B shows the trimming operation 36, where the laser beam from laser scanner 18 precisely cuts current collector foils through the laser trim window 28. During this stage, the foil scrap suction system 32 would be active to remove trimmed material. FIG. 3C shows step 38 where a tab is inserted and positioned on top of a trimmed foil stack. At this point, the laser scanner 18 would be transitioning its alignment from the trim window 28 to the weld window 26. FIG. 3D shows the laser welding operation 40, where the laser scanner 18 directs its beam through the laser weld window 26, creating a bond between a tab and a trimmed foil stack.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While the specific embodiments of the electrode structures, methods of forming such structures, and the resulting battery systems have been described in detail, these embodiments are illustrative and not exhaustive of all potential configurations. The language used in this specification is for descriptive purposes only and should not be interpreted as limiting the scope of the invention. Modifications and variations can occur without departing from the core inventive concepts described herein. Additionally, the features and elements of various embodiments may be combined in novel ways to form additional embodiments within the scope of the claimed subject matter, even if such combinations are not explicitly detailed in this specification.

In certain embodiments, the system may include a control system that coordinates and manages operations, such as platform movement and the sequential firing of the laser for trimming and welding operations. The control system may also include a memory component to store operational parameters, dimensional check data, and quality control information. This memory allows the controller to adjust laser settings, maintain data for later analysis, and ensure that the manufacturing processes follow a predetermined sequence, further increasing the flexibility and precision of the disclosed methods and systems.

What is claimed is:

1. A system for manufacturing battery cells comprising:
a single battery assembly station including a laser mask defining windows, a laser configured to generate beams through the windows, and a platform operable to move a battery cell within the laser mask for the beams to sequentially trim current collector foils of the battery cell and weld tabs to the current collector foils.

2. The system for manufacturing battery cells of claim 1 wherein the windows include a first set of windows for trimming operations and a second set of windows for welding operations.

3. The system for manufacturing battery cells of claim 1, further comprising a vision system integrated within the single battery assembly station for performing dimensional checks of the current collector foils and tabs.

4. The system for manufacturing battery cells of claim 1 wherein the platform is configured to move in at least two dimensions to position the battery cell relative to the laser mask.

5. The system for manufacturing battery cells of claim 1, further comprising a control system programmed to coordinate movement of the platform and firing of the laser to perform trimming and welding operations in a predetermined sequence.

6. The system for manufacturing battery cells of claim 1 wherein the laser is a fiber laser configured to operate at different power levels for trimming and welding operations.

7. The system for manufacturing battery cells of claim 1 wherein the laser mask includes a scrap suction system.

8. A method for manufacturing battery cells comprising:
trimming current collector foils of a battery electrode jellyroll using a laser;
performing a dimensional check of the trimmed current collector foils using a vision system;
welding tabs to the trimmed current collector foils using the laser; and
performing a dimensional check of the welded tabs.

9. The method of claim 8, further comprising adjusting parameters of the laser between the trimming and welding.

10. The method of claim 8 wherein the trimming and welding are performed at a single workstation without moving the battery electrode jellyroll to a separate station.

11. The method of claim 8, further comprising applying a clamping force to the current collector foils during the welding.

12. The method of claim 8 wherein the dimensional checks are performed using machine vision algorithms to analyze images of the trimmed current collector foils and welded tabs.

13. The method of claim 8, further comprising storing dimensional check data.

14. The method of claim 8, further comprising guiding laser beams from the laser through different windows in a laser mask for the trimming and welding.

15. A battery cell assembly system comprising:
a single battery cell workstation including an integrated vision system, a laser source, a beam delivery system defining a path for directing a laser beam from the laser source, a platform operable to translate a battery, within the single battery cell workstation, for the laser beam to sequentially trim and weld foil tabs of the battery, and a conveyor configured to transport battery cells to and from the platform within the single battery cell workstation.

16. The battery cell assembly system of claim 15, further comprising a fume suction system configured to remove fumes generated during laser trimming and welding operations.

17. The battery cell assembly system of claim 15 wherein the beam delivery system includes scrap suction system configured to collect and remove foil scraps produced during laser trimming operation.

18. The battery cell assembly system of claim 15 wherein the platform is configured to translate in at least two dimensions to position the battery relative to the laser source.

19. The battery cell assembly system of claim 15 wherein the laser source is configured to produce different beam profiles for trimming and welding operations.

20. The battery cell assembly system of claim 15, further comprising a control system programmed to coordinate translation of the platform and firing of the laser source to perform trimming and welding operations in a predetermined sequence.
